(19) United States
(12) Patent Application Publication
(10) Pub. No.: US 2007/0093584 A1
(43) Pub. Date: Apr. 26, 2007

(54) Flame-retardant polymers with glow-wire resistance

(75) Inventors: Sebastian Hoerold, Sulzbach (DE); Christian Steib, Sulzbach (DE); Ottmar Schacker, Sulzbach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/582,092

(22) Filed: Oct. 17, 2006

(30) Foreign Application Priority Data
Oct. 22, 2005 (DE) 10 2005 050704.2

(51) Int. Cl. C08K 3/32; C08K 3/40

(52) U.S. Cl. 524/414; 524/494

(57) ABSTRACT

The invention relates to flame-retardant polymers with glow-wire resistance, which comprise as component A, from 40 to 90% by weight of polymer, as component B, from 0 to 40% by weight of reinforcing material, as component C, from 3 to 15% by weight of red phosphorus, as component D, from 5 to 20% by weight of inorganic phosphate, as component E, from 0 to 10% by weight of further additives, the entirety of the components always amounting to 100% by weight.

The present invention is described in the German priority application No. 10 2005 050704.2, filed 22 Oct. 2005, which is hereby incorporated by reference as is fully disclosed herein.

The invention relates to flame-retardant polymers with glow-wire resistance and to polymeric molding compositions which comprise a particular flame retardant combination.

Polymers are often rendered flame-retardant via additions of phosphorus-containing or halogen-containing compounds. Red phosphorus has proven to be a particularly effective flame-retardant additive for thermoplastic polymers (Staendeke, H., Scharf, D., Kunststoffe 11, 79,1989, and Levchik, G. F., Vorobyova, S. A., Gorbarenko, V. V., and Levchik, S., Weil, E. D., Journal of Fire Science, Vol. 18 May/June 2000, pp. 172-183). UL 94 V-0 classification at 0.8 mm is achieved using 7.5% of red phosphorus in reinforced and unreinforced polyamide.

DE-A-102 24 887 describes polymers comprising a combination of red phosphorus, zinc borate, talc, and a lanthanoid compound. This combination achieves an improvement in glow-wire resistance GWFI to IEC 60695-2-12, to 960° C.

DE-A-198 27 845 describes thermoplastic polyester molding compositions with a nitrogen compound and also with an inorganic and an organic phosphorus compound. The inorganic phosphorus compound comprises phosphinates, and red phosphorus is among the organic phosphorus compounds mentioned.

DE-A-101 30 831 describes halogen-free flame-retardant polyester molding compositions which comprise red phosphorus, nitrogen-containing compounds, and very small amounts of hydrotalcite.

JP-A-10 182 940 describes flame-retardant epoxy resins with addition of melamine polyphosphate, and with phenolic-resin-encapsulated red phosphorus.

JP-A-2001164063 describes polymer mixtures composed of styrene polymers and of polycarbonates or of polyesters with melamine polyphosphate and red phosphorus.

JP-A-11246778 discloses flame-retardant polymers with red phosphorus and with tetrazoles, silicone powders, melamine polyphosphate, hydrated magnesium silicates, hydrated calcium borates, or vermiculite.

Finally, JP-A-2003041098 describes polyesters with triazine compounds and with phosphates, phosphorus-containing triazine compounds, or encapsulated red phosphorus, and with a resin having aromatic ring structures.

The effect of red phosphorus and synergists such as melamine polyphosphates is in essence described for fire test purposes by UL 94 vertical tests. However, the effect of the individual compounds remains unsatisfactory in specific thermoplastics. Furthermore, the effect in the IEC 60695-2-12 and -13 glow-wire test remains inadequate. The relatively large amounts of melamine polyphosphate which have to be added for the UL 94 test also cause polymer degradation and discoloration of the flame-retardant plastics, and at present this cannot be effectively countered.

Compliance with the IEC 60695-2-12 and -13 glow-wire standard is to be prescribed for use in household devices.

In particular with regard to the property known as GWIT (glow-wire ignition temperature), there is an insufficient number of available polymeric materials that achieve an ignition temperature above 750° C.

It was therefore an object of the present invention to provide flame-retardant polymers with glow-wire resistance, and in particular polyamides, complying with the fire standards demanded in the electrical and electronics sector, having good processability, and having adequate mechanical properties.

This object is achieved via the use of red phosphorus with inorganic phosphates, and also, if appropriate, addition of further additives, and also of fillers and reinforcing materials.

The present invention therefore provides flame-retardant polymers with glow-wire resistance, which comprise,
as component A, from 40 to 90% by weight of polymer,
as component B, from 0 to 40% by weight of reinforcing material,
as component C, from 3 to 15% by weight of red phosphorus,
as component D, from 5 to 20% by weight of inorganic phosphate,
as component E, from 0 to 10% by weight of further additives,
the entirety of the components always amounting to 100% by weight.

The flame-retardant polymers with glow-wire resistance preferably comprise amounts of from 45 to 65% by weight of component A.

The flame-retardant polymers with glow-wire resistance particularly preferably comprise amounts of from 50 to 65% by weight of component A.

The flame-retardant polymers with glow-wire resistance preferably comprise amounts of from 25 to 35% by weight of component B.

The flame-retardant polymers with glow-wire resistance preferably comprise amounts of from 5 to 10% by weight of component C.

The flame-retardant polymers with glow-wire resistance particularly preferably comprise amounts of from 7 to 10% by weight of component C.

The flame-retardant polymers with glow-wire resistance preferably comprise amounts of from 5 to 15% by weight of component D.

The flame-retardant polymers with glow-wire resistance particularly preferably comprise amounts of from 5 to 12% by weight of component D.

The flame-retardant polymers with glow-wire resistance preferably comprise amounts of from 0.05 to 10% by weight of component E.

The flame-retardant polymers with glow-wire resistance preferably comprise amounts of from 0.1 to 5% by weight of a further component E.

The polymers are preferably polyamides.

The polymers are particularly preferably reinforced polyamides.

Preferred reinforcing materials present are glass fibers and/or mineral fillers.

The red phosphorus present in the flame-retardant polymers with glow-wire resistance is preferably stabilized red phosphorus.

The red phosphorus has preferably been stabilized with magnesium, tin, aluminum, silver, or a combination thereof.

The particle size of the red phosphorus is preferably <200 μm.

The inorganic phosphates (component D) are preferably substantially water-insoluble phosphates, such as monocalcium phosphate, dicalcium phosphate, tricalcium phosphate, calcium pyrophosphate, magnesium phosphate, dimagnesium phosphate, trimagnesium phosphate, magnesium metaphosphate, manganese phosphate, dimanganese phosphate, trimanganese phosphate, zinc phosphate, trizinc phosphate, zinc pyrophosphate, aluminum phosphate, trialuminum phosphate, aluminum metaphosphate, and boron phosphate.

The inorganic phosphates (component D) are preferably substantially water-insoluble phosphates, such as calcium pyrophosphate, magnesium metaphosphate, zinc pyrophosphate, aluminum metaphosphate, and boron phosphate.

The inorganic phosphate is in particular calcium. pyrophosphate.

The reinforcing materials are preferably glass fibers, glass beads, or mineral reinforcing materials.

The additive is preferably stabilizers, processing aids, antidrip agents, dyes, pigments, and/or waxes.

The flame-retardant polymers with glow-wire resistance particularly preferably comprise
as component A, from 50 to 65% by weight of polymer,
as component B, from 25 to 35% by weight of reinforcing material,
as component C, from 7 to 10% by weight of red phosphorus,
as component D, from 5 to 12% by weight of inorganic phosphate,
as component E, from 0.05 to 5% by weight of further additives,
the entirety of the components always amounting to 100% by weight.

For the purposes of the present invention, the amount of red phosphorus (component C) used is from 3 to 15% by weight, preferably from 5 to 10% by weight, particularly preferably from 7 to 10% by weight, based on the mixing specification of the compounded material. The stated percentages by weight are the total proportion of phosphorus in the respective molding composition, inclusive of the stabilizers encapsulating reagents and/or phlegmatizers described above and applied to the red phosphorus.

Surprisingly, it has been found that inventive combinations of red phosphorus and inorganic phosphates, e.g. calcium phosphates, aluminum phosphates, zinc phosphates, magnesium phosphates, manganese phosphates, and boron phosphates, comply with the fire requirements of UL 94 V-0, have a GWFI of 960° C. to IEC 60695-1-12, and also have markedly improved GWIT glow-wire resistance to IEC 60695-2-13. The inventive flame retardant combinations have good processability and give flame-retardant polymers with very good mechanical properties.

Inorganic phosphates, such as sodium, potassium, or calcium phosphates, are used as fertilizers, metal cleaners, and phosphating agents, and also as food additive. The use as flame retardant is not very familiar, since the action of the phosphates is normally insufficient.

In essence, those used as flame retardants are ammonium phosphates and melamine phosphates.

In the present context, red phosphorus is any of the colored allotropic forms of phosphorus, preference being given to red phosphorus or types of phosphorus whose proportion of red phosphorus is greater than 95%. The average particle size of these particles is from 200 to 1 μm, preferably from 100 to 10 μm, particularly preferably from 80 to 20 μm. The red phosphorus used here may be untreated or may have been prestabilized and/or microencapsulated and/or phlegmatized with known agents.

Phlegmatizers which may be used here are conventional reagents, such as mineral oils, paraffin oils, chloroparaffins, polytetrahydrofurans, esters of trimellitic acid, preferably of alcohols having from 6 to 13 carbon atoms, e.g. trioctyl trimellitate, and organic phosphate compounds. It is also possible to use esters of phthalic acid, which can usually be prepared from phthalic acid and from alcohols having from 6 to 13 carbon atoms. Examples of these compounds are dipentyl phthalate, dihexyl phthalate, diheptyl phthalate, dioctyl phthalate, or di-2-ethylhexyl phthalate. It is also possible to use metal salt/metal compounds based inter alia on aluminum, zinc, or calcium, e.g. aluminum oxide or aluminum hydroxide, and these can also simultaneously have stabilizing effect. Chao, Wu et al., “A comprehensive survey of chemical dust suppressants in the world over the last 15 years”, Progress in Safety Science and Technology, Beijing, China, Aug. 10-13, 2000 (2000), (Pt. 2), 705-719 also gives an overview of phlegmatizers that can be used, supplementing the compounds listed above.

Red phosphorus can be microencapsulated with agents known per se.

Examples of these are polymeric compounds, such as cyclohexanone resins, melamine resins, phenol-isobutyraldehyde resins, urea-melamine-phenol-formaldehyde resins, phenol-formaldehyde resins, urea-resorcinol-formaldehyde resins, urea-resorcinol-formaldehyde-hexamethylenetetramine resins, the latter in particular prepared from a mixture of from 0.4 to 4% of urea, from 2 to 20% of resorcinol, from 5 to 97.5% of formaldehyde, and from 0.1 to 8% of hexamethylenetetramine, based in each case on the weight of red phosphorus used, or epoxy resins.

It is moreover also possible per se to prestabilize the red phosphorus via application of inorganic substances. Among these are, by way of example, metal salts or metal compounds, inter alia of aluminum, iron, calcium, cadmium, cobalt, nickel, magnesium, manganese, silver, tin, zinc, or titanium. Those particularly suitable here are the oxides, carbonates/oxycarbonates, hydroxides, and salts of organic acids. It is also possible to use compounds such as silicon dioxide.

The specifications DE-A-196 19 701, DE-A-26 25 673, EP-A-0 195 131, EP-A-0 052 217, and WO 87/00187, inter alia, give examples of red phosphorus pretreated as described above.

For the purposes of the present invention, the form in which the red phosphorus is introduced into the molding compositions may be either that of a powder or else that of concentrates. These concentrates are generally polymeric carrier materials with a proportion of from 40 to 70% by weight of phosphorus, based on the total weight of the concentrate. Typical polymeric carrier materials in this context are polyamides as described above, preferably nylon-6 and nylon-6,6, particularly preferably nylon-6, and the materials described above which are polyesters, epoxy resins, phenolic resins, ester waxes, LDPE or EVA. Phenolic resins are also particularly preferred.

Inorganic phosphates (component D) are reaction products of alkaline compounds, such as calcium oxide, aluminum oxide, zinc oxide, or manganese oxide, with phosphoric acid or with condensed phosphoric acids.

The quantitative proportions of components A, B, C, D, and E in the polyamide with glow-wire resistance are substantially dependent on the intended application sector, and can vary within wide limits. Depending on the application sector, the inventive polymer comprises, as component A, from 40 to 90% by weight of polyamide; as component B, from 0 to 40% by weight of reinforcing materials, such as glass fibers, glass beads, or mineral reinforcing materials; as component C, from 3 to 15% by weight of red phosphorus; as component D, from 5 to 20% by weight of an inorganic phosphate and as component E, optionally from 0 to 10% by weight of further additives.

In one preferred embodiment, the polymer comprises, as component A, from 45 to 65% by weight of polyamide; as component B, from 20 to 35% by weight of reinforcing materials, such as glass fibers, glass beads, or mineral reinforcing materials; as component C, from 5 to 10% by weight of red phosphorus; as component D, from 5 to 15% by weight of an inorganic phosphate; and as component E, from 0 to 5% by weight of further additives, where the entirety of the components always amounts to 100% by weight.

In one particularly preferred embodiment, the polymer comprises, as component A, from 45 to 65% by weight of polyamide; as component B, from 20 to 35% by weight of reinforcing materials, such as glass fibers, glass beads, or mineral reinforcing materials; as component C, from 5 to 10% by weight of red phosphorus; as component D, from 5 to 15% by weight of an inorganic phosphate; and as component E, from 0.1 to 5% by weight of further additives, where the entirety of the components always amounts to 100% by weight.

The invention also provides a flame-retardant plastics molding composition comprising the inventive flame retardant combination.

The plastic is preferably thermoplastic polymers or blends composed of two or more different polymers. Among these are thermoplastic polymers such as homo- and copolymers of olefinically unsaturated monomers, e.g. polyfluoroethylenes, polyethylene, polypropylene, ethylene-propylene copolymers, polystyrene, styrene-acrylonitrile copolymers, ABS copolymers (acrylonitrile-butadiene-styrene), vinyl chloride homo- and copolymers, polyacrylates, in particular polymethyl methacrylate, vinyl acetate copolymers, polyacetals, polycarbonates, polyesters, and polyamides. Polyamides and polyesters are preferred, and in the present context polyamides are particularly preferred.

Suitable polyamides are known homopolyamides, copolyamides, and mixtures of these polyamides. These may be semicrystalline and/or amorphous polyamides.

Suitable semicrystalline polyamides are nylon-6, nylon-6,6, and mixtures and appropriate copolymers composed of these components.

Other semicrystalline polyamides which may be used are those whose acid component is composed entirely or to some extent of terephthalic acid and/or of isophthalic acid and/or of subaric acid and/or of sebacic acid and/or of azelaic acid and/or of adipic acid and/or of cyclohexanedicarboxylic acid, whose diamine component is entirely or to some extent composed of m- and/or p-xylylenediamine and/or of hexamethylenediamine and/or of 2,2,4-trimethylhexamethylenediamine and/or of 2,2,4-trimethyl-hexamethylenediamine and/or of isophoronediamine, and whose constitution is known in principle.

Mention may also be made of polyamides prepared entirely or to some extent of lactams having from 7 to 12 carbon atoms in the ring, if appropriate with concomitant use of one or more of the abovementioned starting components.

Particularly preferred semicrystalline polyamides are nylon-6,6 and nylon-6 and their mixtures, very particular preference being given to nylon-6,6. Amorphous polyamides which may be used comprise known products. They are obtained via polycondensation of diamines, such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclo-hexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane, and/or 1,4-diaminomethylcyclohexane with dicarboxylic acids, such as oxalic acid, adipic acid, azelaic acid, decanedicarboxylic acid, heptadecanedicarboxylic acid, 2,2,4- and/or 2,4,4-trimethyladipic acid, isophthalic acid, and terephthalic acid.

Copolymers obtained via polycondensation of two or more monomers are also suitable, as are copolymers prepared with addition of aminocarboxylic acids, such as aminocaproic acid, aminoundecanoic acid, or aminolauric acid, or of their lactams.

Particularly suitable amorphous polyamides are the polyamides prepared from isophthalic acid, hexamethylenediamine, and other diamines, such as 4,4′-diaminodicyclohexylmethane, isophoronediamine, 2,2,4- and/or 2,4,4-trimethylhexa-methylenediamine, 2,5- and/or 2,6-bis(aminomethyl)norbornene; or from isophthalic acid, 4,4′-diaminodicyclohexylmethane and caprolactam; or from isophthalic acid, 3,3′-dimethyl-4,4′-diaminodicyclohexylmethane and laurolactam; or from terephthalic acid and the isomer mixture composed of 2,2,4- and/or 2,4,4-trimethylhexamethylenediamine.

Instead of pure 4,4′-diaminodicyclohexylmethane, it is also possible to use mixtures of the positional isomers of diaminodicyclohexylmethane, these being composed of
from 70 to 99 mol % of the 4,4′-diamino isomer
from 1 to 30 mol % of the 2,4′-diamino isomer
from 0 to 2 mol % of the 2,2′-diamino isomer, and
if appropriate, corresponding diamines of higher condensation level, obtained via hydrogenation of technical-grade diaminodiphenylmethane. Terephthalic acid can replace up to 30% of the isophthalic acid.

Suitable reagents may also have been used to introduce branching into the polyamides described or to lengthen their polymer chains appropriately. Branching agents or chain extenders which may be used are low-molecular-weight and oligomeric compounds which have at least two reactive groups which can react with primary and/or secondary amino groups, and/or with amide groups, and/or with carboxylic acid groups. Examples of reactive groups are isocyanates, which may, if appropriate, have been capped, epoxides, maleic anhydrides, oxazolines, oxazines, oxazolones, and the like. Preference is given to diepoxides based on diglycidyl ethers (bisphenol and epichlorohydrin), based on amine-epoxy resin (aniline and epichlorohydrin), based on diglycidyl esters (cycloaliphatic dicarboxylic acids and epichlorohydrin), individually or in mixtures, and 2,2-bis[p-hydroxyphenyl]propane diglycidyl ether, bis[p-(N-methyl-N-2,3-epoxypropyl)aminophenyl]methane. Glycidyl ethers are particularly preferred, and very particular preference is given to bisphenol A diglycidyl ether.

The polymer moldings, polymer films, polymer filaments, and polymer fibers involve HI (high-impact) polystyrene, polyphenylene ether, polyamides, polyesters, polycarbonates, and blends or polyblends of the type represented by ABS (acrylonitrile-butadiene-styrene) or PC/ABS (polycarbonate/acrylonitrile-butadiene-styrene), polyamide, or polyester, preferably polyamide.

The abovementioned additives (component C-E) may be introduced into the plastic in a very wide variety of steps of the process. For example, in the case of polyamides, the additives may be admixed with the polymer melt at the very start of the polymerization/polycondensation process, or at its end, or in a subsequent compounding process. There are also processes in which the additives are not added until later. This method is used particularly when using masterbatches of pigments or of additives. It is also possible to apply in particular pulverulent additives in a drum to the polymer pellets, which may have retained some heat from the drying process.

The preferred form of the red phosphorus is that of a melt mixture or that of a masterbatch. Concentrates in phenolic resins are particularly preferred.

The polyamides are preferably those of amino acid type and/or of diamine-dicarboxylic acid type.

The polyamides are preferably nylon-6, nylon-12, semiaromatic polyamides, and/or nylon-6,6.

The polyamides are preferably unmodified, colored, filled, unfilled, reinforced, or unreinforced polyamides, or else have been modified in some other way.

Fibrous or particulate fillers and reinforcing materials (component B) which may be added to the inventive molding compositions are glass fibers, glass beads, glass textile, glass mats, carbon fibers, aramid fibers, potassium titanate fibers, natural fibers, amorphous silica, magnesium carbonate, barium sulfate, feldspar, mica, silicates, quartz, kaolin, talc, titanium dioxide, wollastonite, inter alia, and these may also have been surface-treated. Preferred reinforcing materials are commercially available glass fibers. The form in which the glass fibers are added may be that of continuous-filament fibers or that of cut or ground glass fibers, the fiber diameter generally being from 8 to 18 μm, and the fibers here may, if appropriate, have been provided with surface modifications, e.g. silanes or glass-fiber sizes. Acicular mineral fillers are also suitable. For the purposes of the invention, acicular mineral fillers are a mineral filler with pronounced acicular character. An example which may be mentioned is acicular wollastonite.

The L/D (length/diameter) ratio of the mineral is preferably from 8:1 to 35:1, with preference from 8:1 to 11:1. The mineral filler may, if appropriate, have been surface-treated.

The inventive polymers and molding compositions may comprise further additives (component E), examples being agents to counteract decomposition caused by heat, agents to counteract crosslinking caused by heat, agents to counteract damage by ultraviolet light, plasticizers, flow aids and processing aids, further flame retardants, lubricants and mold-release agents, nucleating agents, antistatic agents, stabilizers, and dyes and pigments.

Specified examples of oxidation retarders and heat stabilizers are sterically hindered phenols and/or phosphites, hydroquinones, aromatic secondary amines, such as diphenylamines, various substituted representatives of these groups, and mixtures of these.

UV stabilizers which may be mentioned are various substituted resorcinols, salicylates, benzotriazoles, and benzophenones.

Colorants which may be used are inorganic pigments, such as titanium dioxide, ultramarine blue, iron oxide, and carbon black, and also inorganic pigments, such as phthalocyanines, quinacridones, perylenes, and dyes, such as nigrosine and anthraquinone, and other colorants. For the purposes of the present invention it is preferable to use carbon black.

Examples of nucleating agents which may be used are sodium phenylphosphinate, aluminum oxide, or silicon dioxide.

Lubricants and mold-release agents generally used are ester waxes, pentaerythritol tetrastearate (PETS), long-chain fatty acids (e.g. stearic acid or behenic acid), the salts of these (e.g. calcium stearate or zinc stearate), and also amide derivatives (e.g. ethylenebisstearylamide), or montan waxes (mixtures of straight-chain, saturated carboxylic acids having chain lengths of from 28 to 32 carbon atoms), and low-molecular-weight polyethylene waxes and low-molecular-weight polypropylene waxes.

Examples which may be mentioned of plasticizers are dioctyl phthalate, dibenzyl phthalate, butyl benzyl phthalate, hydrocarbon oils, and N-(n-butyl)benzenesulfonamide.

Examples of further flame retardants which may be used are phosphorus-containing flame retardants selected from the groups of the mono- and oligomeric phosphoric and phosphonic esters, phosphonates, phosphinates, phosphites, hypophosphites, phosphine oxides, and phosphazenes, and the flame retardants used may also comprise mixtures of two or more components selected from one or more of these groups. It is also possible to use other, preferably halogen-free, phosphorus compounds not specifically mentioned here, alone or in any desired combination with other, preferably halogen-free, phosphorus compounds.

### EXAMPLES

1. Components Used

Commercially available polymers (pellets):

| | |
|---|---|
| Component A: | |
| Nylon-6,6 (PA 6.6): | ® Durethan A 30 (Bayer AG, D) |
| Component B: | |
| ® Vetrotex EC 10 P983 | Glass fibers (Vetrotex, D) |

Flame retardant components:
Component C:
®Exolit RP 695, Clariant GmbH, Sulzbach, D
Masterbatch composed of 50% stabilized and microencapsulated red phosphorus in nylon-6
Component D:
C 54-80 neutral calcium pyrophosphate
Z34-80 zinc pyrophosphate
M16-04 aluminum metaphosphate
B13-04 boron phosphate
M16-54 magnesium metaphosphate
all from Chemische Fabrik Budenheim, Budenheim, D
   2. Preparation, Processing, and Testing of Flame-Retardant Plastics Molding Compositions

The flame retardant components were mixed in the ratio stated in the tables with the polymer pellets and, if appropriate, with the stabilizer, and incorporated in a twin-screw extruder (Leistritz ZSK 27/44) at temperatures of from 260 to 310° C. (GRPA 6.6). The homogenized polymer extrudate was drawn off, cooled in a water bath, and then pelletized.

After adequate drying, the molding compositions were processed in an injection molding machine (Arburg 320 C Allrounder) at melt temperatures of from 270 to 320° C. (GRPA 6.6) to give test specimens, and tested and classified for flame retardancy on the basis of the UL 94 test (Underwriters Laboratories). The properties evaluated here are, inter alia, afterflame times and drip performance of ASTM standard test specimens.

For classification of a flame-retardant plastic in fire classification UL 94 V-0, the specific criteria which have to be met are as follows: for a set of 5 ASTM standard test specimens (dimensions: 127×12.7×X, where X=3.2; 1.6, and 0.8 mm), none of the specimens may have an afterflame time longer than 10 seconds after two flame applications of duration 10 seconds using an open flame of defined height. The total of the afterflame times for 10 flame applications to 5 specimens may not be greater than 50 seconds. Other criteria which have to be met are: no flaming drips, no complete consumption of the specimen, and afterglow time for each test specimen no longer than 30 seconds. The classification UL 94 V-1 demands that the individual afterflame times are not longer than 30 seconds, and that the total of the afterflame times for 10 flame applications to 5 specimens is not greater than 250 seconds. The total afterglow time may not be more than 250 seconds. The other criteria are identical with those mentioned above. Classification in fire classification UL 94 V-2 applies when flaming drips are produced but the other criteria of UL 94 V-1 classification are met.

For electronic components in household devices, an additional requirement is the test for flame retardancy of plastics in the glow-wire test: GWFI to IEC 60695-2-12 and GWIT to IEC 60695-2-13. The general procedure here uses 3 test specimens (for example plaques of dimensions 60×60×1 mm) and a glowing wire at temperatures of from 550 to 960° C. to determine, as GWFI, the maximum temperature at which an afterflame time of 30 seconds is not exceeded and the specimen does not produce any flaming drips. The temperature determined as GWIT is higher by 25° C. than the maximum glow-wire temperature which does not lead to ignition of the specimen (ignition meaning here that a flame is visible for longer than 5 seconds). This test, too, is of particular interest in the electrical and electronic sector, because the temperatures reached in electronic equipment in the event of a defect, or on overloading, are sufficiently high to cause ignition of parts in the immediate vicinity. The glow-wire test simulates this type of thermal stress. For unrestricted use in household devices, the test specimen has to have a GWFI of 850° C. and a GWIT of 775° C.

The flowability of the molding compositions was determined via determination of the melt volume index (MVR) at 275° C./2.16 kg. A sharp rise in the MVR value indicates degradation of the polymer.

Unless otherwise stated, identical conditions (temperature profiles, screw geometries, injection-molding parameters, etc.) were used for reasons of comparability in all of the experiments of each series.

Table 1 shows comparative examples in which red phosphorus, calcium pyrophosphate (CaPP), zinc pyrophosphate (ZnPP), and aluminum metaphosphate (AIMP) were used as flame retardant.

TABLE 1
Comparative examples: flame-retardant molding compositions with the
components as individual additives in Durethan A 30 glass-fiber-
reinforced PA 6.6 with 30% of Vetrotex EC 10 P 983 glass fibers.

| | | | | | UL 94 | GWIT/IEC | |
|---|---|---|---|---|---|---|---|
| | Exolit RP | CaPP | ZnPP | AIMP | classification | 60695-2- | MVR |
| Comparison | 695 [%] | [%] | [%] | [%] | (0.8 mm) | 13 [° C.] | [cm³/10′] |
| c1 | 10 | 0 | 0 | 0 | n.c. | 700 | 19 |
| c2 | 15 | 0 | 0 | 0 | v-0 | 725 | 21 |
| c3 | 0 | 10 | 0 | 0 | n.c. | 650 | 25 |
| c4 | 0 | 20 | 0 | 0 | n.c. | 700 | 23 |
| c5 | 0 | 0 | 10 | 0 | n.c. | 625 | 21 |
| c6 | 0 | 0 | 20 | 0 | n.c. | 550 | 21 |
| c7 | 0 | 0 | 0 | 10 | n.c. | 600 | 21 |
| c8 | 0 | 0 | 0 | 20 | n.c. | 650 | 21 |

*) not classifiable, i.e. afterflame time too long

Use of red phosphorus achieves UL 94 V-0, but not GWIT >775° C. Similarly, with the inorganic phosphates studied no classification is achieved and the GWIT achieved is no more than 700° C. No flame-retardant action of the inorganic phosphates is discernible.

The results of the inventive examples which used the flame retardant mixture of the invention are listed in table 2. All of the amounts are stated as % by weight, and are based on the plastics molding composition inclusive of the flame retardant combination and additives.

TABLE 2
Inventive combination (ie1-ie7) of red phosphorus and
inorganic phosphate in GR nylon-6,6

| | Exolit | | | | | | |
|---|---|---|---|---|---|---|---|
| | RP | | | | UL 94 | GWIT/IEC | |
| Inventive | 695 | CaPP | ZnPP | AIMP | classification | 60695-2-13 | |
| example | [%] | [%] | [%] | [%] | (0.8 mm) | [° C.] | MVR [cm³/10′] |
| ie1 | 10 | 5 | 0 | 0 | V-0 | 775 | 17 |
| ie2 | 12 | 5 | 0 | 0 | V-0 | 775 | 14 |
| ie3 | 12 | 10 | 0 | 0 | V-0 | 800 | 15 |
| ie4 | 12 | 0 | 5 | 0 | V-0 | 775 | 13 |
| ie5 | 12 | 0 | 10 | 0 | V-0 | 775 | 12 |
| ie6 | 12 | 0 | 0 | 5 | V-0 | 750 | 11 |
| ie7 | 12 | 0 | 0 | 10 | V-0 | 800 | 15 |

Although red phosphorus alone (comparative example c1, c2) achieves V-0, it achieves only a GWIT of from 725 to 750° C. The inventive combination of red phosphorus and inorganic phosphates (ie1-ie7) achieves not only V-0 but also a GWIT of 775° C. or 800° C. The MVR of ie1 to ie7 is below 20 cm³/10 min, and therefore the mixing specifications exhibit no degradation of the polymer. The inventive mixing specifications have good processability and have very good thermal stability, and have good mechanical and electrical properties (e.g. CTI 600V).

1. A flame-retardant polymer with glow-wire resistance, comprising
as component A, from 40 to 90% by weight of polymer,
as component B, from 0 to 40% by weight of reinforcing material,
as component C, from 3 to 15% by weight of red phosphorus,
as component D, from 5 to 20% by weight of inorganic phosphate,
as component E, from 0 to 10% by weight of at least one additive,
the entirety of the components always amounting to 100% by weight.

2. The flame-retardant polymer with glow-wire resistance, as claimed in claim 1, comprising of from 45 to 65% by weight of component A.

3. The flame-retardant polymer with glow-wire resistance, as claimed in claim 1 comprising from 50 to 65% by weight of component A.

4. The flame-retardant polymer with glow-wire resistance, as claimed in claim 1, comprising from 25 to 35% by weight of component B.

5. The flame-retardant polymer with glow-wire resistance, as claimed in claim 1, comprising from 5 to 10% by weight of component C.

6. The flame-retardant polymer with glow-wire resistance, as claimed in claim 1, comprising from 7 to 10% by weight of component C.

7. The flame-retardant polymer with glow-wire resistance, as claimed in claim 1, comprising from 5 to 15% by weight of component D.

8. The flame-retardant polymer with glow-wire resistance, as claimed in claim 1, comprising from 5 to 12% by weight of component D.

9. The flame-retardant polymer with glow-wire resistance, as claimed in claim 1, comprising from 0.05 to 10% by weight of component E.

10. The flame-retardant polymer with glow-wire resistance, as claimed in claim 1, comprising from 0.1 to 5% by weight of component E.

11. The flame-retardant polymer with glow-wire resistance, as claimed in claim 1, wherein the polymer is a polyamide.

12. The flame-retardant polymer with glow-wire resistance, as claimed in claim 1, wherein the polymer is a reinforced polyamide.

13. The flame-retardant polymer with glow-wire resistance, as claimed in claim 12, wherein the reinforced polyamide is reinforced with glass fibers, mineral fillers or a mixture thereof.

14. The flame-retardant polymer with glow-wire resistance, as claimed in claim 1, wherein the red phosphorus is stabilized red phosphorus.

15. The flame-retardant polymer with glow-wire resistance, as claimed in claim 13, wherein the stabilized red phosphorus is stabilized with magnesium, tin, aluminum, silver, or a combination thereof.

16. The flame-retardant polymer with glow-wire resistance, as claimed in claim 1, wherein the particle size of red phosphorus is <200 μm.

17. The flame-retardant polymer with glow-wire resistance as claimed in claim 1, wherein the inorganic phosphate is monocalcium phosphate, dicalcium phosphate, tricalcium phosphate, calcium pyrophosphate, magnesium phosphate, dimagnesium phosphate, trimagnesium phosphate, magnesium metaphosphate, manganese phosphate, dimanganese phosphate, trimanganese phosphate, zinc phosphate, trizinc phosphate, zinc pyrophosphate, aluminum phosphate, trialuminum phosphate, aluminum metaphosphate, or boron phosphate.

18. The flame-retardant polymer with glow-wire resistance, as claimed in claim 1, wherein the inorganic phosphate is calcium pyrophosphate, magnesium metaphosphate, zinc pyrophosphate, aluminum metaphosphate, or boron phosphate.

19. The flame-retardant polymer with glow-wire resistance as claimed in claim 1, wherein the inorganic phosphate is calcium pyrophosphate.

20. The flame-retardant polymer with glow-wire resistance, as claimed in claim 12, wherein the reinforced polyamide is reinforced with glass fibers, glass beads, or mineral reinforcing materials.

21. The flame-retardant polymer with glow-wire resistance, as claimed in claim 1, wherein the at least one additive is selected from the group consisting of stabilizers, processing aids, antidrip agents, dyes, pigments, waxes and mixtures thereof.

22. A flame-retardant polymer with glow-wire resistance comprising
as component A, from 50 to 65% by weight of polymer,
as component B, from 25 to 35% by weight of reinforcing material,
as component C, from 7 to 10% by weight of red phosphorus,
as component D, from 5 to 12% by weight of inorganic phosphate,
as component E, from 0.05 to 5% by weight of at least one additive,
the entirety of the components always amounting to 100% by weight.

23. A polymeric molding composition comprising a flame-retardant polymer with glow-wire resistance according to claim 1.

24. A polymeric molding composition comprising a flame-retardant polymer with glow-wire resistance according to claim 22.
